(19) United States
(12) Patent Application Publication
(10) Pub. No.: US 2026/0285205 A1
(43) Pub. Date: Sep. 24, 2026

(54) UNLOCKING ARRANGEMENT FOR SEAT BACK ADJUSTMENT

(71) Applicant: AUDI AG, lngolstadt (DE)

(72) Inventor: Bernd SCHMOLL, Pappenheim (DE)

(73) Assignee: AUDI AG, lngolstadt (DE)

(21) Appl. No.: 19/475,825

(22) PCT Filed: May 29, 2024
(86) PCT No.: PCT/EP2024/064743

§ 371 Date: Oct. 16, 2025

(30) Foreign Application Priority Data
Jun. 15, 2023 (DE) 102023115724.8

(51) Int. Cl. B60N 2/225; B60N 2/90

(52) U.S. Cl. CPC B60N 2/2251; B60N 2/933

(57) ABSTRACT

An unlocking arrangement, in particular for a seat back adjustment, includes an operating element which is rotatable along a rotation axis, which is connected to a gear and actuates the gear in a rotational manner by a rotational movement about the rotation axis, and a locking fitting which can be unlocked by a movement of an output of the gear. The operating element is hollow with an internal transmission contour, and the internal transmission contour is coupled to the gear.

### FIELD

The invention relates to an unlocking arrangement, in particular for a seat back adjustment, comprising an operating element rotatable along a rotation axis. Furthermore, the invention relates to a vehicle seat and a vehicle.

### BACKGROUND

Vehicles usually have at least two vehicle seats with seat back adjustment installed. This allows the inclination or angle of the seat back to be changed relative to the seat surface. The seat back is connected to the seat surface by means of a hinge and is usually fitted with a locking mechanism which prevents accidental adjustment of the seat back.

The locking fitting must be unlocked in advance to adjust the inclination of the seat back, for example by rotating a spring-loaded unlocking axis which is connected to the locking fitting. The unlocking elements currently used, for example locking backrests on the front seats of a vehicle, are usually implemented directly and without a gear transmission. In order to set the unlocking forces sufficiently low or acceptable for the user, such unlocking forces must be applied by operating elements that are dimensioned accordingly large or long in order to achieve a leverage effect.

The problem here, however, is the limited installation space in the region between the vehicle seat and a vehicle door. Therefore, a compromise must be found between an operating stroke and an operating force. However, such a compromise is detrimental in terms of ergonomics and design. In addition, depending on the seating position, access to the operating element may be restricted by the seat belt strap, particularly in the front seats of the vehicle.

### SUMMARY

It is the object of the present invention to provide an unlocking arrangement and a vehicle seat by means of which an operating element for unlocking and adjusting a seat back can be designed to be particularly compact.

This object is achieved according to the invention by an unlocking arrangement, by a vehicle seat and by a vehicle.

The unlocking arrangement according to the invention is used in particular for seat back adjustment. The unlocking arrangement can unlock a seat back of a seat, for example a vehicle seat, in its locking position and change an angle of inclination of the seat back. For this purpose, the unlocking arrangement has an operating element which can be rotated along a rotational axis and which is connected to a gear and which actuates the gear in a rotational manner by means of a rotational movement about the rotational axis or rotary shaft of the gear.

The actuation of the gear can, for example, be carried out by a transmission or reduction in the form of a rotary movement or by converting a rotary movement into a translational movement.

Furthermore, the unlocking arrangement has a locking fitting which can be unlocked by a movement of an output of the gear.

Advantageously, the operating element is hollow with an internal transmission contour, wherein the internal transmission contour is coupled to the gear. By rotating the operating element, the internal transmission contour can act on the gear and thus result in the seat back adjustment being unlocked and the inclination of a seat back being changed.

According to a further aspect of the invention, a vehicle seat is provided which has an unlocking arrangement according to the invention. The unlocking arrangement is advantageously positioned laterally in the region of a hinge between a seat back and a seat surface of the vehicle seat. The inclination of the seat back can be adjusted using an operating element in the unlocking arrangement.

According to a further aspect of the invention, a vehicle is provided. The vehicle has at least one vehicle seat according to the invention. Such a vehicle seat can be adjusted with minimal effort using the unlocking arrangement.

By at least partially integrating a gear into the operating element or an internal volume of the operating element, the required installation space for the unlocking arrangement can be reduced and, for example, unlocking of a locking backrest on the front seat can be realized with minimal operating force.

For this purpose, the gear can partially protrude into the inner volume of the operating element or be completely integrated into the inner volume of the operating element in order to interact with the internal transmission contour.

The unlocking arrangement according to the invention thus makes it possible to save the required installation space and to reduce the operating force required to unlock and adjust the seat back.

The reduction in installation space and the possibility of reducing the size of the operating element due to the lower operating force can also prevent unwanted interaction with a belt strap that is arranged on the side of a vehicle seat.

According to an exemplary embodiment, the internal transmission contour of the operating element and the gear are designed as a planetary transmission. Advantageously, the operating element is designed as a ring gear, which drives planetary gears of the gear with the internal transmission contour. This measure enables mechanical force transmission within the internal volume of the operating element.

In an alternative or additional embodiment, the operating element has an internal transmission contour which is designed as a sun gear in order to drive the planetary gears by a rotational movement of the operating element.

According to a further embodiment, the planetary gears are fixed in their position or at least limited in their range of movement and drive a centrally arranged sun gear, which is designed as the output of the gear. When the operating element is actuated, a force is transmitted between the internal transmission contour and the immovably positioned planetary gears or planet gears, which then transmit the operating force to the sun gear, which is surrounded by the planetary gears. The sun gear is also arranged, at least in part, in the internal volume of the operating element. The sun gear is driven to rotate by the operating force and can thus actuate the unlocking axis of the locking fitting in order to unlock it and adjust the backrest.

Alternatively, the planetary gears are fixed in their position and can be driven or rotated by a centrally arranged sun gear. The planetary gears are designed to drive an internal transmission contour of a web, which is designed as the output of the gear. The sun gear can be coupled to the operating element or designed as an integral part of the operating element. The operating element can be pushed over the web and locked in place so that it can rotate. Depending on the design, the web can function as a guide bearing or guide sleeve for a rotary movement of the operating element. Turning the operating element causes the web to rotate due to the meshing of the sun gear with the planetary gears, which web is rotated within the operating element and drives the locking fitting or the output of the gear.

According to a further exemplary embodiment, the sun gear is arranged in a rotationally fixed manner on the rotation axis of the operating element. In particular, the sun gear can be connected to the operating element in a rotationally fixed manner or can be designed as an integral part of the operating element. The planetary gears are connected to each other via a web, wherein the web is designed to be non-rotatable or only rotatable to a limited extent around the rotation axis. This measure prevents the planetary gears from rotating around the sun gear and thus changing their position along a circular path.

Depending on the design, the rotation of the planetary gears around the sun gear can be limited to a predefined angular range in order to implement the unlocking of the locking fitting.

The web can rotate with the planetary gears, each of which can rotate about its own axis, and around the rotation axis of the operating element or the ring gear, and can be used to unlock the locking fitting.

In particular, the operating element and the sun gear can be arranged rotationally symmetrically or coaxially to the rotation axis and in particular have a common rotation axis.

The unlocking arrangement can be made particularly compact if the rotation axis of the operating element is designed as a rotation axis for the gear and as an unlocking axis for the locking fitting. As a result of this measure, the rotation axis of the operating element, the symmetry axis or rotation axis of the sun gear and, depending on the design, the rotation axis of the web which couples the planetary gears to each other, are congruent with each other and with the unlocking axis.

According to a further exemplary embodiment, the internal transmission contour of the operating element or the web is designed as an internal toothing or a friction surface. Advantageously, the operating element is designed to be closed on one side and has a structuring on one outer surface. Due to the structuring on the outer surface, a user of the unlocking arrangement can transfer or apply an operating force to the operating element particularly conveniently. The design of the internal transmission structure in the form of an internal toothing enables a technically particularly simple design of the gear.

In an alternative embodiment, the respective components of the gear mechanism can be designed in the form of friction surfaces instead of gears in order to implement the unlocking and back adjustment.

According to a further embodiment, the gear is arranged in an internal volume of the operating element. In particular, the entire gear can be arranged within the internal volume. This measure enables a particularly compact gear transmission of the operating force to be achieved. In addition to reducing the size of the operating element, the transmitted operating force can be increased many times over in order to unlock the locking fitting and adjust the seat back.

### BRIEF DESCRIPTION OF THE FIGURES

The invention is schematically illustrated in the drawings with the aid of embodiments and is described further with reference to the drawings. In the figures:

FIG. 1 shows a vehicle seat of a vehicle according to an exemplary embodiment of the invention.

FIG. 2 shows an unlocking arrangement according to an exemplary embodiment of the invention.

FIG. 3 shows steps for illustrating a structure of the unlocking arrangement of FIG. 2.

### DETAILED DESCRIPTION

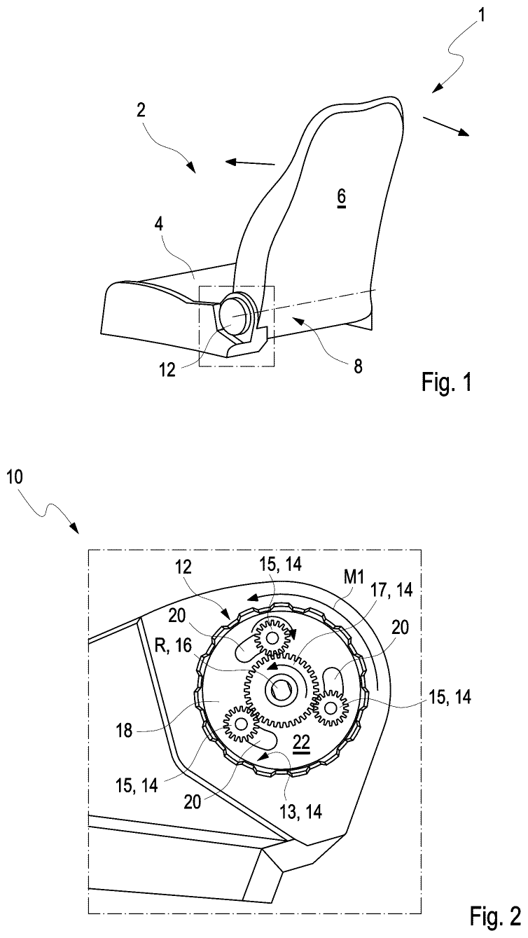

FIG. 1 shows a vehicle seat 2 of a vehicle 1 according to an exemplary embodiment of the invention. For the sake of clarity, an interior of the vehicle 1 is shown schematically with only one vehicle seat 2.

The vehicle seat 2 is designed, for example, as a driver's seat. The vehicle seat 2 has a seat surface 4 and a seat back 6. The seat surface 4 and the seat back 6 are connected to each other by means of a hinge 8 in such a way that a seat back adjustment is possible.

The seat back adjustment allows an adjustment of the angle of inclination of the seat back. This is illustrated schematically by the arrows. An unlocking arrangement 10 is provided for this purpose.

The unlocking arrangement 10 for the seat back 6 of the seat 2, which is designed as a vehicle seat by way of example, serves to unlock a locking device of the vehicle seat 2 and to change the angle of inclination of the seat back 6. For this purpose, the unlocking arrangement 10 has an operating element 12 which can be rotated along a rotation axis R and which can be actuated by a user (not shown), such as a driver or passenger. The operating element 12 can be actuated by a rotary movement or a torque M1. This corresponds to applying an operating force to the operating element 12.

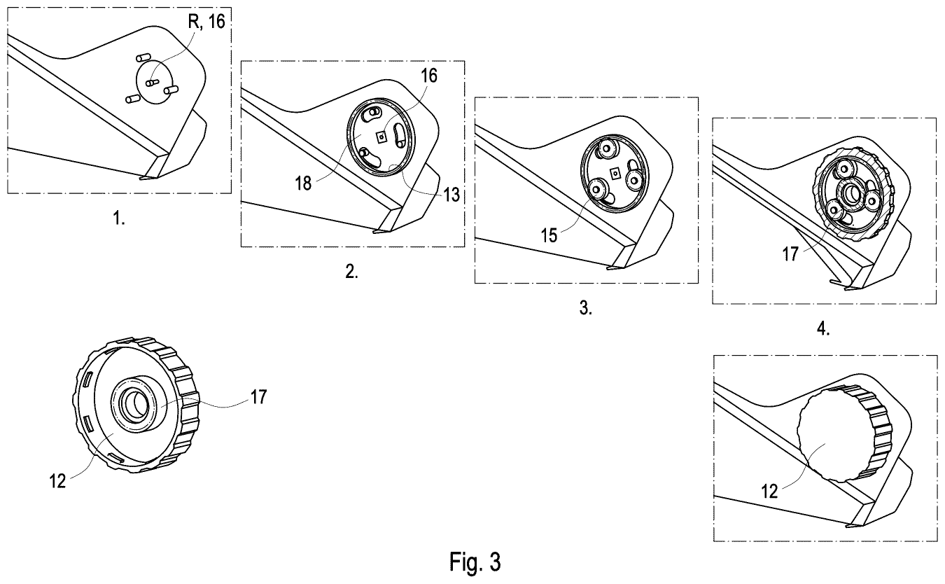

FIGS. 2 and 3 show detailed views of the unlocking arrangement 10 according to an exemplary embodiment of the invention. The seat back adjustment is unlocked by rotating the operating element 12, which is illustrated by the arrows. For this purpose, the unlocking arrangement 10 has the operating element 12 which can be rotated along a rotational axis R and which is connected to a gear 14 and which actuates the gear 14 in a rotational manner by means of a rotational movement about the rotational axis R.

In the illustrated exemplary embodiment, the torque M1 is converted into a rotary movement by the gear 14. Furthermore, the unlocking arrangement 10 has a locking fitting 16 which can be unlocked by a movement of an output of the gear 12. The locking fitting 16 is positioned behind the operating element 12 and has an unlocking axis that corresponds to the rotation axis R.

The operating element 12 is hollow with an internal transmission contour in the form of a sun gear 17. This is, for example, a component of the gear 14. By rotating the operating element 12, the sun gear 17 can act on the other parts of the gear 14 and thus result in an unlocking of the seat back adjustment and a change in the inclination of the seat back 6.

Furthermore, in the illustrated exemplary embodiment, a ring gear in the form of a web 18 is provided. The ring gear 18 has an internal transmission contour 13, which is part of the gear 14.

The operating element 12 and the ring gear 18 with the internal transmission contour 13 can be designed in two parts or in one part. For example, a ring gear with the internal transmission contour 13 can function as a receiving section for the operating element 12 and be covered on the outside by the operating element 12. In the illustrated exemplary embodiment, the sun gear 17 is integrally connected to the operating element 12. The ring gear 18 acts as a guide sleeve for the operating element 12. Alternatively, the operating element 12 can be mounted and positioned via a guide section in the region of the sun gear 17.

The operating element 12 drives, via the sun gear 17, planetary gears 15 of the gear 14, which in turn drive the inner transmission contour 13 of the ring gear or web 18.

The planetary gears 15 are limited in their range of movement and are driven by the centrally arranged sun gear 17 of the operating element 12. The web 18 acts as the output of the gear 14. The planetary gears 15 are limited in their range of motion in that they can only perform one rotation. For this purpose, rotation axes or shafts of the planetary gears 15 are attached directly to the seat 2.

The output of the gear 14 is connected to the unlocking axis of the locking fitting 16.

The rear side of the ring gear 18 with the internal transmission contour 13 functions here as a web 18 for the planetary gears 15 of the gear 14. In the illustrated exemplary embodiment, the planetary gears 15 of the gear 14 cannot change position within the recesses 20. The ring gear with the internal transmission contour 13 can be rotated due to the recesses 20 designed as elongated holes.

The entire gear 14 is arranged in an internal volume 22 of the operating element 12.

### LIST OF REFERENCE NUMERALS

1 vehicle
2 vehicle seat
4 seat surface
6 seat back
8 hinge
10 unlocking arrangement
12 operating element
13 transmission contour
14 gear
15 planetary gears
16 locking fitting
17 sun gear
18 web
20 recesses
22 internal volume
M1 torque/operating force
R rotation axis/unlocking axis

1-9. (canceled)

10. An unlocking arrangement, in particular for a seat back adjustment, comprising: an operating element which is rotatable along a rotation axis, which is connected to a gear and actuates the gear in a rotational manner by a rotational movement about the rotation axis, and comprising a locking fitting which can be unlocked by a movement of an output of the gear, characterized in that the operating element is hollow with an internal transmission contour, wherein the internal transmission contour is coupled to the gear.

11. The unlocking arrangement according to claim 10, wherein the internal transmission contour of the operating element and the gear are designed as a planetary gear, wherein the operating element is designed as a ring gear which drives planetary gears with the internal transmission contour or wherein the operating element has an internal transmission contour which is designed as a sun gear in order to drive the planetary gears.

12. The unlocking arrangement according to claim 11, wherein the planetary gears are fixed in their position and drive a centrally arranged sun gear which is designed as the output of the gear, or wherein the planetary gears are fixed in their position and can be driven by a centrally arranged sun gear, wherein the planetary gears are designed to drive an internal transmission contour of a web which is designed as the output of the gear.

13. The unlocking arrangement according to claim 11, wherein the sun gear is arranged in a rotationally fixed manner on the rotation axis of the operating element, in particular is connected to the operating element, wherein the planetary gears are connected to one another via a web.

14. The unlocking arrangement according claim 10, wherein the rotation axis of the operating element is designed as a rotation axis for the gear and as an unlocking axis for the locking fitting.

15. The unlocking arrangement according to claim 10, wherein the inner transmission contour of the operating element or web is designed as an internal toothing or a friction surface, wherein the operating element is designed to be closed on one side and has a structuring on a lateral surface.

16. The unlocking arrangement according to claim 10, wherein the gear is arranged in an internal volume of the operating element.

17. A vehicle seat, comprising an unlocking arrangement according to claim 10, wherein the unlocking arrangement is positioned laterally in the region of a hinge between a seat back and a seat surface of the vehicle seat, wherein an inclination of the seat back is adjustable by an operating element of the unlocking arrangement.

18. A vehicle comprising at least one vehicle seat according to claim 17.

19. The unlocking arrangement according to claim 12, wherein the sun gear is arranged in a rotationally fixed manner on the rotation axis of the operating element, in particular is connected to the operating element, wherein the planetary gears are connected to one another via a web.

20. The unlocking arrangement according claim 11, wherein the rotation axis of the operating element is designed as a rotation axis for the gear and as an unlocking axis for the locking fitting.

21. The unlocking arrangement according claim 12, wherein the rotation axis of the operating element is designed as a rotation axis for the gear and as an unlocking axis for the locking fitting.

22. The unlocking arrangement according claim 13, wherein the rotation axis of the operating element is designed as a rotation axis for the gear and as an unlocking axis for the locking fitting.

23. The unlocking arrangement according to claim 11, wherein the inner transmission contour of the operating element or web is designed as an internal toothing or a friction surface, wherein the operating element is designed to be closed on one side and has a structuring on a lateral surface.

24. The unlocking arrangement according to claim 12, wherein the inner transmission contour of the operating element or web is designed as an internal toothing or a friction surface, wherein the operating element is designed to be closed on one side and has a structuring on a lateral surface.

25. The unlocking arrangement according to claim 13, wherein the inner transmission contour of the operating element or web is designed as an internal toothing or a friction surface, wherein the operating element is designed to be closed on one side and has a structuring on a lateral surface.

26. The unlocking arrangement according to claim 14, wherein the inner transmission contour of the operating element or web is designed as an internal toothing or a friction surface, wherein the operating element is designed to be closed on one side and has a structuring on a lateral surface.

27. The unlocking arrangement according to claim 11, wherein the gear is arranged in an internal volume of the operating element.

28. The unlocking arrangement according to claim 12, wherein the gear is arranged in an internal volume of the operating element.

29. The unlocking arrangement according to claim 13, wherein the gear is arranged in an internal volume of the operating element.
